(19) United States
(12) Patent Application Publication
(10) Pub. No.: US 2026/0124900 A1
(43) Pub. Date: May 7, 2026

(54) A CONTROLLED ENGINE ASSIST SYSTEM

(71) Applicant: DEERE & COMPANY, MOLINE, IL (US)

(72) Inventor: Satyanarayana PS, PUNE (IN)

(21) Appl. No.: 19/234,355

(22) Filed: Jun. 11, 2025

(30) Foreign Application Priority Data
Nov. 4, 2024 (IN) 202421084043

(51) Int. Cl. B60K 6/38

(52) U.S. Cl. CPC B60K 6/38; B60Y 2200/92

(57) ABSTRACT

A controlled engine assist system for a hybrid vehicles having an internal combustion engine and an electric power source with a battery. The system comprises a shaft connecting the internal combustion engine and a torque cushioning clutch. A power transmission arrangement couples the torque cushioning clutch to the electric power source. The torque cushioning clutch partially transmits torque from the internal combustion engine to the electric power source during recuperation. This regulates transmission of sudden rotational irregularities to the electric power source, thereby, minimizing potential damage to the electric power source.

### CROSS-REFERENCE TO RELATED APPLICATIONS

This application claims priority under 35 U.S. C. § 119 to patent application IN 202421084043, filed on 4 Nov. 2024, the disclosure of which is incorporated herein by reference.

### FIELD OF THE DISCLOSURE

The present disclosure relates generally to vehicle transmission systems and more particularly to hybrid vehicles having two sources of power.

### BACKGROUND OF THE DISCLOSURE

Hybrid vehicles typically include two power sources, an engine and an electric power source. Torque is transmitted from the engine to the electric power source for operating as a generator to charge a battery associated with the electric power source, which selectively supplies power to the engine.

Hybrid vehicles can often recover vehicle energy during braking and this provides a power boost to the internal combustion engine during peak load. This facilitates cranking of the engine, thereby reducing fuel consumption and carbon dioxide emissions. In existing hybrid vehicles, the engine is coupled to the electric power source though a belt. The poses belt tensioning challenges. Hence, belt tensioners are required to be utilized to continuously monitor and manage the belt tension with an optimum value. The belt tensioner increases belt tension during a cranking mode, a boost mode, that is, transmission of torque from the engine to the electric power source and during recuperation, that is, torque transmission from electric power source to the engine. Alternatively, the belt tensioner is required to reduce tension during normal driving to minimize friction loss.

As the belt is part of power transmission between the engine and the electric power source, speed and torque fluctuations create high forces on the belt especially during boost mode and recuperation. During acceleration and deceleration of the engine, forces acting on the electric power source result in rotational irregularities. This causes adverse effects on the belt and the electric power source. The electric power source being expensive, such adverse effects require extensive cost of maintenance and majority of the time it is required to be replaced.

In view of the above, there is a requirement for a system which can minimize damage to the electric power source due to rotational irregularities transmitted by the engine.

### SUMMARY OF THE DISCLOSURE

An object of the present disclosure is to minimize impact of a sudden change in engine torque on an electric power source of a hybrid vehicle. Another object of the present disclosure is to minimize the maintenance cost and replacement cost for the electric power source. Other objects of the present disclosure will be apparent when the description of the disclosure is read in conjunction with the accompanying drawings.

In accordance with the present disclosure there is provided a controlled engine assist system for a hybrid vehicle having an internal combustion engine and an electric power source with a battery. The system comprises a shaft connecting the internal combustion engine and a torque cushioning clutch. The torque cushioning clutch is configured to be in an engaged configuration and a disengaged configuration. A power transmission arrangement couples the clutch to the electric power source. The torque cushioning clutch is configured to assist in transmitting controlled torque from the internal combustion engine to the electric power source. The torque cushioning clutch may be a slip assist clutch such as a mechanical slipper clutch, a hydraulic slipper clutch, or an electromagnetic slipper clutch. The electric power source is selectively operable to transmit torque to the internal combustion engine.

The torque cushioning clutch is configured to positively transmit torque from the electric power source to the internal combustion engine during a start-up mode and a power boost mode of the hybrid vehicle. The electric power source is configured to selectively operate as a motor and a generator for supplying torque to the internal combustion engine and charging the battery, respectively. The torque cushioning clutch partially transmits torque from the internal combustion engine to the electric power source during recuperation.

Other features and aspects will become apparent by consideration of the detailed description and accompanying drawings.

### BRIEF DESCRIPTION OF THE DRAWINGS

FIG. 1 illustrates an internal combustion engine connected to an electric power source via a torque cushioning clutch, a power transmission arrangement, and a shaft.

### DETAILED DESCRIPTION

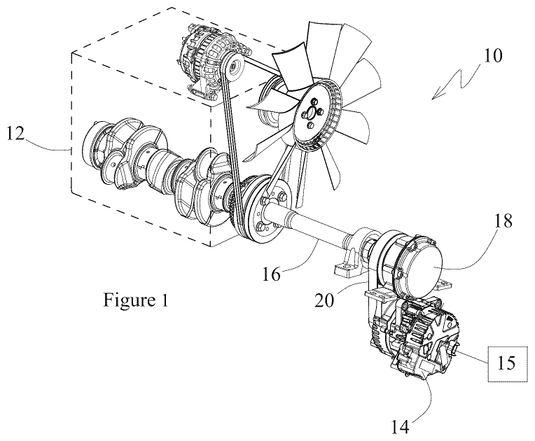

FIG. 1 shows a controlled engine assist system (10). A hybrid vehicle (not shown in FIGURE) has an internal combustion engine (12) and an electric power source (14) with a battery (15). A shaft (16) connects the internal combustion engine (12) with a torque cushioning clutch (18). The torque cushioning clutch (18) is shifted between an engaged configuration and a disengaged configuration, based on predefined modes of operation of the internal combustion engine (12). The torque cushioning clutch (18) may comprise a slip assist clutch such as a mechanical slipper clutch, a hydraulic slipper clutch, or an electromagnetic slipper clutch. The predefined modes include a start-up mode, a power boost mode, and a charging mode or during recuperation.

A power transmission arrangement (20) couples the electric power source (14) to the shaft (16). The electric power source (14) is selectively operable to transmit torque to the internal combustion engine (12). The power transmission arrangement (20) may be formed by a belt and pulley arrangement, as indicated in FIG. 1. Alternatively, the power transmission arrangement (20) may be formed by a gear arrangement.

The torque cushioning clutch (18), in accordance with the present disclosure, operates in such a way as to allow smooth power flow from the electric power source (14) to the internal combustion engine (12), while facilitating to partially slip when power flows from the internal combustion engine (12) to the electric power source (14). Thus, when power flows from the electric power source (14) to the internal combustion engine (12) to provide extra torque, henceforth termed as boost mode, the torque cushioning clutch (18) is locked into place. This increases a clamping force of the torque cushioning clutch (18), creating a strong, slip-free connection. This allows power from the electric power source (14) to flow directly to the internal combustion engine (12) without any slip or delay. On the other hand, when power flows from the internal combustion engine (12) to the electric power source (14) a controlled slip or delay in transmitting torque comes into effect. During deceleration, braking, or situations where power from the internal combustion engine (12) flows toward the electric power source (14), the torque cushioning clutch (18) activates the pressure plate to gradually slide in a controlled manner. This sliding reduces the clamping force of the torque cushioning clutch (18), thereby, permitting a controlled, partial slip. This prevents harsh engagement of the torque cushioning clutch (18) during flow of power from the internal combustion engine (12) to the electric power source (14), which allows for a smoother, controlled deceleration, resulting in protection of the electric power source (14) and the power transmission arrangement (20) from excessive strain. Thus, the torque cushioning clutch (18) optimizes power transfer from the electric power source (14) to the internal combustion engine (12).

In the charging mode, while the electric power source (14) acts as a generator, the torque cushioning clutch (18) is engaged. Meanwhile, the internal combustion engine (12), in addition to being in the propelling condition to propel the vehicle or the engine idling condition, a portion of the power from the internal combustion engine (12) is transmitted from the shaft (16) via the torque cushioning clutch (18) and further to the electric power source (14) via the power transmission arrangement (20). The power from the internal combustion engine (12) is transmitted to the electric power source (14) via the power transmission arrangement (20), acting as a generator for charging the battery (15). Simultaneously, the power from the internal combustion engine (12) may be transmitted for propelling the vehicle as needed.

The electric power source (14) operates as a motor for supplying torque to the internal combustion engine (12). The electric power source (14) comprises a motor such as an induction motor, a synchronous motor, a brushed motor, or a brushless motor. The electric power source (14) operates as a generator for charging the battery (15). Such electric power source (14) which is operable as a motor as well as a generator is known in the art and such conversion and operation thereof happens in a known manner. In the charging mode, the electric power source (14) acts as a generator for charging the battery (15). In the charging mode or during recuperation, while the electric power source (14) acts as a generator, the torque cushioning clutch (18) partially transmits torque from the internal combustion engine (12) to the electric power source (14).

During operation of the vehicle, the torque cushioning clutch (18) operates in a known way to assist transmitting controlled torque from the internal combustion engine (12) to the electric power source (14). The torque cushioning clutch (18) positively transmits torque from the electric power source (14) to the internal combustion engine (12), during the start-up mode and the power boost mode of the hybrid vehicle. The start-up mode is a mode wherein the internal combustion engine (12) is required to be cranked. The trigger for cranking of the internal combustion engine (12) is transmitted from the electric power source (14) to the torque cushioning clutch (18) via the power transmission arrangement (20). In the power boost mode, both the electric power source (14) and the internal combustion engine (12) generate power which is supplied to propel the vehicle.

Thus, appropriately positioning the torque cushioning clutch (18), between the internal combustion engine (12) and the electric power source (14), regulates transmitting sudden rotational irregularities to the electric power source (14). This helps in minimizing damage to the electric power source (14).

The present disclosure has several technical advancements, including but not limited to the realization of minimizing impact of sudden change in engine torque on an electric power source of a hybrid vehicle.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A controlled engine assist system for a hybrid vehicle having an internal combustion engine and an electric power source with a battery, the system comprising:
a torque cushioning clutch configured to be in an engaged configuration and a disengaged configuration;
a shaft connecting the internal combustion engine and the torque cushioning clutch; and
a power transmission arrangement coupling the torque cushioning clutch to the electric power source.

2. The system as claimed in claim 1, wherein the torque cushioning clutch is configured to assist in transmitting controlled torque from the internal combustion engine to the electric power source.

3. The system as claimed in claim 1, wherein the torque cushioning clutch comprises a slip assist clutch.

4. The system as claimed in claim 1, wherein the electric power source is selectively operable to transmit torque to the internal combustion engine.

5. The system as claimed in claim 1, wherein the torque cushioning clutch is configured to positively transmit torque from the electric power source to the internal combustion engine during a start-up mode and a power boost mode of the hybrid vehicle.

6. The system as claimed in claim 1, wherein the electric power source is configured to selectively operate as a motor and a generator for supplying torque to the internal combustion engine and charge the battery, respectively.

7. The system as claimed in claim 1, wherein the torque cushioning clutch partially transmits torque from the internal combustion engine to the electric power source during recuperation.
